(19) United States
(12) Patent Application Publication
(10) Pub. No.: US 2014/0054146 A1
(43) Pub. Date: Feb. 27, 2014

(54) Driven Machine Tool, in Particular an Angle Grinder or a Straight Grinder

(71) Applicant: Matthias Hiller, Altenriet (DE)

(72) Inventor: Matthias Hiller, Altenriet (DE)

(73) Assignee: METABOWERKE GMBH, Nuertingen (DE)

(21) Appl. No.: 13/971,502

(22) Filed: Aug. 20, 2013

(30) Foreign Application Priority Data
Aug. 23, 2012 (DE) 102012215025.0

(51) Int. Cl. H01H 3/04

(52) U.S. Cl. CPC H01H 3/04
USPC 200/329

(57) ABSTRACT

The present invention relates to a driven machine tool, and in particular to an angle grinder or a straight grinder, and which includes a drive unit having a drive switch for switching the drive unit on and off, a housing in which the drive unit is at least partially received, and an actuation mechanism for actuating the drive switch.

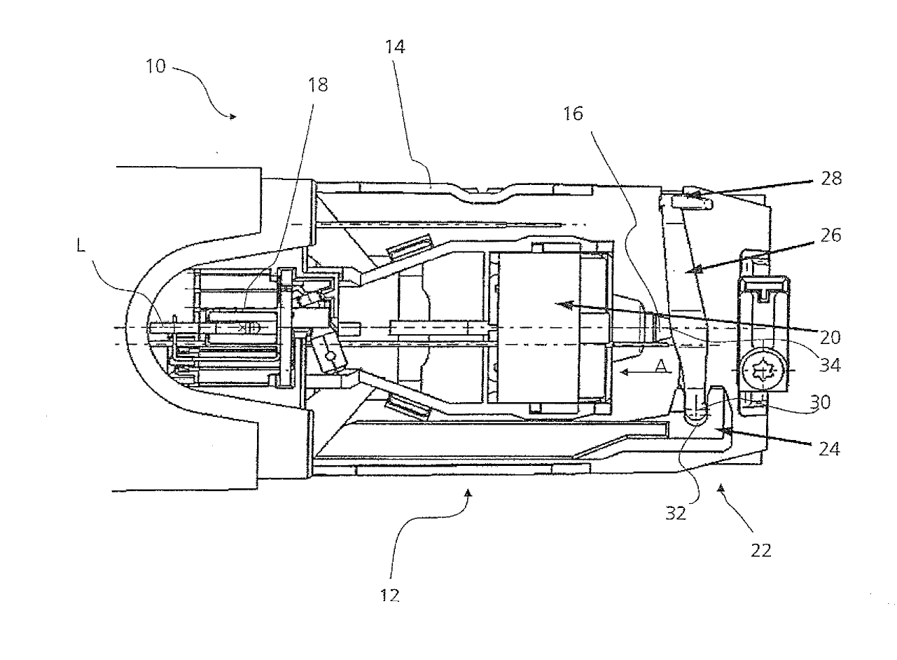

### RELATED PATENT DATA

The present application claims priority from German Patent Application Serial No. 10 2012 215 025.0, and which was filed on Aug. 23, 2012.

The present invention relates to a driven machine tool, and in particular to an angle grinder or a straight grinder, comprising a drive unit having a drive switch for switching the drive unit on and off, a housing in which the drive unit is at least partially received, and an actuation mechanism for actuating the drive switch.

Such a driven machine tool is known, for example, from the German laid-open application DE 10 2007 025 009 A1. In order to actuate the drive switch, the actuation mechanism known from the prior art comprises a sliding switching member or a switching rod which is actuated by means of a switch button or actuation portion which is accessible to the user from the outer side and which is displaced relative to the housing. As a result of a displacement of the sliding switching member or the switching rod, a portion of the switching rod, which portion is bent at right-angles relative to the longitudinal axis of the switching rod, presses on the drive switch, whereby it is displaced and activated.

Such an angled switching rod has the advantage of providing a particularly simple actuation mechanism. However, the use of such an angled switching rod has been found to be disadvantageous in practice in devices which are used in an operating environment in which a large proportion of dust particles is present in the ambient air. These particles may become introduced into the housing. This is because the dust particles can accumulate in the region of the actuation mechanism, whereby the switching rod is potentially impeded in terms of its displacement movement and thereby becomes difficult to move. This is in particular also caused by comparatively high transverse forces, which have to be applied via the angled portion of the switching rod so that the drive switch can be displaced in order to be switched on.

It is further known from the German patent specification DE 35 40 652 C2 in relation to an electrical screwdriver to provide an actuation mechanism in which, by pressing the tool in one direction, a switching rod is moved in the same direction and in turn pivots a dual lever in order to displace a pin counter to the pretensioning force of a compression spring and thereby to close an electrical switch. In this embodiment, it is possible to dispense with an actuation portion, in which the user introduces the displacement of the switching rod.

The laid-open application DE 10 2005 021 731 A1 (U.S. Pat. No. 4,617,843) discloses an electrical tool having a device member which is arranged in a housing and a handle, a switch being arranged and provided in the handle. This switch is intended to be connected indirectly to a switching element which is arranged in the device member in order to actuate an electrical on/off switch. To this end, a Bowden cable is provided. The lever-like switching element has an upper and a lower lever arm and is pivotably supported about a rotation location. The Bowden cable is connected at one end to the lower lever arm of the switch. For switching, a switch detent is provided and is connected to the other end of the Bowden cable and which can be displaced in a translatory manner during a switching movement.

The Utility Model DE 20 2011 108 753 U1 (US Patent Publication Number 2013140051 (A1)) further discloses for operating a switch a pivotable operating lever which can be pivoted about a bearing location and which pivots an intermediate lever which is coupled thereto and which actuates the switch.

Finally, the laid-open application DE 32 36 713 A1 discloses a switch device having a switching member which is constructed so as to be able to slide and be tilted.

An object of the present invention is to further develop the known mechanism having an angled switching rod in such a manner that, even in a working environment with a high occurrence of dust, reliable switching on and off of the machine tool is ensured.

To this end, the present invention proposes a driven machine tool, and in particular an angle grinder or a straight grinder, having the features of Claim 1. Accordingly, the actuation mechanism has a switching rod which can be displaced along the longitudinal axis of the housing and which protrudes through a recess of the housing with an actuation portion, and a switching lever which is pivotably supported at a bearing location and which has at least one lever arm. The switching rod is further connected to the at least one lever arm according to the invention and can pivot it as a result of its displacement.

In this manner, the switching lever can be pivoted in the direction towards the drive switch and pressed into a switched-on or energized state, or can be pivoted away therefrom, whereby switching off or deenergizing is achieved. To this end, the switching lever has at least one lever arm, which extends from the bearing location thereof as far as the force application or force introduction location, at which the switching rod is coupled to the at least one lever arm. Depending upon the construction of the housing inner space, however, a dual-arm switching lever may also be advantageous.

As a result of the use of a switching lever, the force introduction location or force application location on the switching rod is displaced in the direction of the actuation axis. Significantly smaller transverse forces which have to be absorbed by the bearing are thereby produced. Furthermore, owing to the lever translation, the switching forces may be larger and, consequently, the switch may be constructed in a more reliable manner. The actuation force is reduced by the provision of the switching lever so that, even when the switching rod becomes more difficult to move as a result of accumulated dust or contamination, the operator does not have to apply any significantly high forces in order to switch the driven machine tool on or off. Finally, owing to the lever translation at the switching rod, there is a larger travel, which may in turn advantageously convey the accumulating dust into non-critical regions.

A commercially available switch, a so-called cube type switch or push type switch, is used as a drive switch. This involves a switch geometry which is offered by a large number of different manufacturers and which has already been used in commercially available machine tools.

The present invention is consequently used together with an already known drive switch, which has the advantage of being able to be retrofitted in already developed machine tools. Another advantage can be seen in that, owing to the use of an existing drive switch, the development and production costs with respect to the drive switch remain the same, whilst the invention provides improved switchability of the machine tool.

There is further provision in accordance with the invention for the bearing location of the switching lever to be arranged on the housing. Particularly simple assembly of the switching lever is thereby enabled.

In one form of the invention, the switching rod may be connected to the at least one lever arm at a free end of the switching lever. Depending upon the configuration of the bearing location, a particularly long lever arm can thereby be provided, whereby the transverse force to be introduced by the switching rod may be comparatively small.

The free end of the connected lever arm may be received in a recess in the switching rod. In this instance, the switching lever may have a rounded outer contour at the free end of the connected lever arm and the recess in the switching rod may have a substantially corresponding contour. Owing to the provision of such a rounded outer contour, which engages in a substantially corresponding inner contour of the recess in the switching rod, an articulated connection of the switching rod with respect to the switching lever is achieved, in which a relative movement of the switching lever with respect to the switching rod (caused by the pivot movements of the lever) is subjected to a lower level of friction. In addition, in the region of the coupling of the switching rod and switching lever, a friction-reducing coating or a friction-reducing material may be used on the switching lever or on the switching rod.

In addition to a machine tool with the above-described features, the invention also relates to an actuation mechanism for actuating a drive switch having the features of Claim 5. This actuation mechanism may further have the above-described features.

The invention is described in greater detail below with reference to the appended FIGURE which shows a preferred embodiment. The features according to the invention are in this instance illustrated in combination with each other. However, the person skilled in the art recognizes them separately from each other and can also optionally combine the individual features of the invention to form other advantageous sub-combinations.

### BRIEF DESCRIPTION OF THE DRAWINGS

The lone FIGURE which is provided is a schematic partially sectioned plan view of the inner side of a housing of a machine tool according to the teachings of the present invention.

### DETAILED DESCRIPTION OF THE INVENTION

The machine tool according to the present invention is illustrated only partially in the drawing and is generally designated by the numeral 10. It has in the region of the handle thereof a housing which extends along a longitudinal axis L and which may be composed of a plurality of housing portions, for example, in a pot-like construction. In the embodiment as illustrated, a housing portion in the handle region 12 is removed in order to enable the inner side of the housing to be seen. The machine housing is generally designated by the numeral 14 independently of the housing portion as shown.

Inside the housing 14, a drive switch 16 can be seen and which is used to switch on (energize) and switch off (deenergize) a drive unit 18. The drive switch 16 is constructed in the embodiment which is illustrated as a pressure switch which is pretensioned in the off position thereof by means of an integrated compression spring (not illustrated). By using the pressure switch 16, and to switch on an associated activation unit 20 so as to supply the drive unit 18 with energy, it is therefore necessary to press the pressure switch or drive switch 16 in the direction towards the drive unit 18 and counter to the action of the integrated spring (indicated by the arrow A).

The actuation mechanism 22 for actuating the drive switch 16 comprises a switching rod 24 and a switching lever 26. The switching rod 24 in this instance performs the function of redirecting an actuation movement by the user from the outer side of the housing into the inner side. To this end, the switching rod 24 has an actuation portion (not illustrated) which protrudes through a recess of the housing 14. This actuation portion can be displaced forwards or backwards in a longitudinal direction L in a known manner by a user in the handle region 12 and within the recess of the housing so as to switch the machine tool on or off. As a result of the displacement of the actuation portion, a displacement of the switching rod 24 is brought about in the direction of the longitudinal axis L. This action, in turn, also carries the coupled switching lever 26 and pivots it about its bearing location 28 on the housing. The switching lever 26 in this instance, inter alia, performs the function of converting the translational displacement of the switching rod 24 into a pivot movement. The drive switch 16 which is in abutment with the switching lever 26 is pressed in the direction A owing to this aforementioned pivot movement.

As can also be seen with reference to the drawings, the illustrated switching lever 26 has a single lever arm, which extends from the bearing location 28 on the housing 14 as far as the force introduction location 30. The force introduction location 30 is the location at which the switching rod 24 is coupled to the switching lever 26 and consequently introduces a compression or tensile force into the switching lever 26. In this region, the switching lever 26 is constructed in a rounded manner at the free end thereof. The associated recess 32, in which the free end of the switching lever 26 is received, has a corresponding contour. A displacement of the switching lever relative to the switching rod 24 is thereby achieved when the switching lever 26 is pivoted, which displacement is friction-free to the greatest possible extent.

The switching lever 16, in the region of a contact location 34, touches the drive switch 16 at least during its pivoting movement in the direction towards the drive switch, the switching lever 26 applying a pressing force to the drive switch 16. The contact location 34 is arranged with smaller spacing from the bearing location 28 than the force introduction location 30. Based on the general principle of moment equilibrium on a lever, a force translation thereby results in which the force introduced by the switching rod 24 is smaller than the compression force applied to the drive switch 16 by a factor by which the spacing from the contact location 34 to the bearing location 28 is smaller than the spacing from the force introduction location 30 to the bearing location 28.

The switching lever 26 and the switching rod 24 do not have to be securely connected to each other. It is sufficient for the switching rod 24 to be coupled to the switching lever in such a manner that the translation movement thereof results in a pivoting action of the switching lever 26.

With the present invention, a particularly simple and cost-effective implementation of an actuation mechanism is proposed. Owing to the use of a switching lever, the compression or tensile forces to be applied by the switching rod are substantially reduced with respect to the prior art. This is, on the one hand, very advantageous for operation by the user since, even when the switching rod has become difficult to move as a result of an accumulation of dust particles, the user further does not have to apply any significantly high forces in order to operate the switching rod. However, it is further also advantageous that, owing to the fact that the actuation force is reduced by the switching lever, smaller reaction forces also act on the switching rod so that it is subjected to a smaller load compared with the prior art. The service-life of the actuation mechanism is thereby increased.

What I claim is:

1. A driven machine tool comprising: a drive unit having a drive switch for switching the drive unit on and off; a housing in which the drive unit is at least partially received; and an actuation mechanism for actuating the drive switch, and wherein the actuation mechanism has a switching rod which can be displaced along a longitudinal axis (L) of the housing and which further protrudes through a recess of the housing and which includes an actuation portion, and a switching lever which is pivotably supported at a bearing location and which further has at least one lever arm, and wherein the switching rod is connected to the at least one lever arm and is further able to pivot the at least one lever arm as a result of the displacement thereof, and wherein the bearing location of the switching lever is borne on the housing.

2. A driven machine tool as claimed in claim 1, and
wherein the switching rod is connected to the at least one lever arm at a free end of the switching lever.

3. A driven machine tool as claimed in claim 2, and
wherein the free end of the connected lever arm is received in a recess defined by the switching rod.

4. A driven machine tool as claimed in claim 3, and
wherein the switching lever has a rounded outer contour at the free end of the connected lever arm and the recess in the switching rod has a substantially corresponding contour.

5. A driven machine tool having a drive switch, comprising: an actuation mechanism having a switching rod which can be displaced along a longitudinal axis (L) of a housing of the driven machine tool and which protrudes through a recess defined by the housing and which includes an actuation portion; and wherein a switching lever is provided, and which is pivotably supported at a bearing location and which further has at least one lever arm having a bearing location, and wherein the switching rod is connected to the at least one lever arm and is able to pivot the at least one lever arm as a result of the displacement thereof, and the bearing location of the switching lever is arranged on the housing.

6. (canceled)
